(19) United States
(12) Patent Application Publication
(10) Pub. No.: US 2017/0041300 A1
(43) Pub. Date: Feb. 9, 2017

(54) ELECTRONIC APPARATUS TO PREDICT PREFERENCE OF USER AND PROVIDE INFORMATION AND CONTROL METHOD THEREOF

(71) Applicant: SAMSUNG ELECTRONICS CO., LTD., Suwon-si (KR)

(72) Inventors: Yu-na KIM, Suwon-si (KR); Sung-wook KIM, Seoul (KR); Jin-su KIM, Seoul (KR); Jun-bum SHIN, Suwon-si (KR)

(21) Appl. No.: 15/227,215

(22) Filed: Aug. 3, 2016

Related U.S. Application Data
(60) Provisional application No. 62/201,179, filed on Aug. 5, 2015.

(30) Foreign Application Priority Data
Jun. 3, 2016 (KR) 10-2016-0069852

(51) Int. Cl. H04L 29/06; G06F 17/16; G06N 5/04

(52) U.S. Cl. CPC H04L 63/0464; G06N 5/04; G06F 17/16; H04L 63/166

(57) ABSTRACT

An electronic apparatus is provided. The electronic apparatus includes, a communicator including communication circuitry, a storage, and at least one processor. The communication circuitry communicates with a plurality of user terminals and an external apparatus. The storage stores information of a plurality of users and a plurality of pieces of content. The at least one processor is configured to receive encrypted preference data of the user to first content from among the plurality of pieces of content from at least one among the plurality of user terminals through the communication circuitry, to transmit the encrypted preference data to the external apparatus, to receive characteristic data generated by applying an external operation and a re-encryption to the decrypted preference data from the external apparatus, to apply an internal operation to information of the plurality of users and the plurality of pieces of content through the received characteristic data, to predict a preference of the user to second content different from the first content based on the information subjected to the internal operation of the plurality of users and the plurality of pieces of content, and to provide the predicted preference information of the user to the second content. Thus, the operation may be performed efficiently and distributed with the external apparatus.

### CROSS-REFERENCE TO RELATED APPLICATION

This application is based on and claims priority under 35 U.S.C. §119 to Korean Patent Application No. 10-2016-0069852, filed on Jun. 3, 2016 in the Korean Intellectual Property Office, and to U.S. provisional patent application Ser. No. 62/201,179, filed on Aug. 5, 2015 in the United States Patents and Trademark Office, the disclosures of which are incorporated by reference herein in their entireties.

### TECHNICAL FIELD

The disclosure relates generally to an electronic apparatus, which predicts a user's preference to various content which the user did not watch and input preference to the electronic apparatus. For example, the electronic apparatus predicts the preference of the user by applying matrix factorization to preference data about content input by a plurality of users and provides relevant information, and a control method thereof.

### BACKGROUND

With rapid development of technology and content, a lot of content and items have been given by a provider. Thus, a consumer has to select desired content in a deluge of content. In this regard, a consumer wants to reduce time and costs by previously receiving information related how much they can enjoy content such as food, books, movies, lodgings, etc.

To this end, a recommendation system has been actively developed to predict preference to content not yet provided to a consumer based on preference to content hitherto provided to the consumer, and to recommend a consumer contents in the form of information that can be provided to the consumer. Users' personal information collected in such a recommendation system is mostly not susceptible to exposure like a user's simple preference to a certain item, but may be used in deducing religious view, sex, age, etc. Therefore, it is important for the recommendation system to not only accurately predict a user's preference but also safely protect information input by a user, and this is a very controversial subject.

Accordingly, there has been introduced a conventional recommendation system employing a garbled circuit developed to predict the preference while protecting a user's personal information. A recommendation server for providing recommendation data to a user receives a user's input, and sends the received input together with an internally set parameter to a crypto service provider (CSP) having a public encryption key. The CSP designs garbled circuit for applying matrix factorization to data input by a bitwise operation so that the data input by a user cannot be exposed, and provides it to the recommendation server. Then, the recommendation server uses the garbled circuit to operate a recommended value, and provides relevant information to a user.

In the conventional recommendation system, the recommendation server cannot directly operate on the encrypted data and the decryption key is not exposed, and therefore it takes a long time to design the garbled circuit that performs the bitwise operation not to expose information being in need of security maintenance. Besides, it takes much time in operation using the designed garbled circuit.

In addition, repetitive operations are impossible since it takes long time to design and use the circuit for one operation, and therefore an operation value is not accurate.

The above information is presented as background information only to assist with an understanding of the present disclosure. No determination has been made, and no assertion is made, as to whether any of the above might be applicable as prior art with regard to the present disclosure.

### SUMMARY

Aspects of the disclosure address at least the above-mentioned problems and/or disadvantages and provide at least the advantages described below. Accordingly, an aspect of the disclosure is to provide an electronic apparatus and method of controlling the electronic apparatus.

In accordance with an aspect of the disclosure, matrix factorization applied to data input for predicting preference is shared between an electronic apparatus and a crypto service provider (CSP), thereby rapidly, efficiently and more accurately providing a recommended value.

In accordance with an example aspect of the disclosure, an electronic apparatus is provided. The electronic apparatus includes a communicator comprising communication circuitry configured to communicate with a plurality of user terminals and an external apparatus; a storage configured to store information of a plurality of users and a plurality of pieces of content; and at least one processor configured to receive encrypted preference data of a user as first content from among the plurality of pieces of content from at least one among the plurality of user terminals through the communication circuitry, to transmit the encrypted preference data to the external apparatus, to receive characteristic data generated by applying an external operation and a re-encryption to decrypted preference data from the external apparatus, to apply an internal operation to information of the plurality of users and the plurality of pieces of content through the received characteristic data, to predict preference of the user to second content different from the first content based on the information subjected to the internal operation of the plurality of users and the plurality of pieces of content, and to provide predicted preference information of the user to the second content.

The encryption and re-encryption may include full homomorphic encryption (FHE).

The at least one processor may apply preprocessing and masking for an external operation to the input data and then transmit the data subjected to the preprocessing and the masking to the external apparatus, and apply unmasking to the received re-encrypted data and apply the internal operation to the data subjected to the unmasking.

The at least one processor may encrypt the information about the plurality of users and the plurality of pieces of content and store the encrypted information in the storage.

The external operation may include a gradient descent operation.

The internal operation may include matrix factorization applied to the plurality of users and the plurality of pieces of content, and the characteristic data generated by the external operation may include a gradient used in the matrix factorization.

The at least one processor may generate a user profile and a content profile by applying the internal operation to the information about the plurality of users and the plurality of pieces of content, and may predict preference of the user to the second content based on the generated user profile and content profile.

The at least one processor may determine whether the received re-encrypted data is within a range of a predetermined critical level, and may transmit the received re-encrypted data to the external apparatus for the external operation if it is determined that the received re-encrypted data is out of the range.

The at least one processor may transmit information about a predetermined critical level and the received re-encrypted data to the external apparatus to determine whether the received re-encrypted data is within a range of a predetermined critical level, and may receive a result of determination from the external apparatus.

The at least one processor may provide information about a user and content, which has been subjected to the internal operation, to a user terminal from among the plurality of user terminals that makes a request for information.

The at least one processor may predict preference to the other content other than the first content from among the plurality of pieces of content, and may provide recommendation content based on the predicted preference of a user to the other content.

The recommendation content may have preference equal to or higher than a critical level from among the plurality of pieces of content.

In accordance with another example aspect of the disclosure, a method of controlling an electronic apparatus is provided. The method includes communicating with a plurality of user terminals and an external apparatus; storing information of a plurality of users and a plurality of pieces of content; receiving encrypted preference data of a user to first content from among the plurality of pieces of content from at least one among the plurality of user terminals; transmitting the encrypted preference data to the external apparatus; receiving characteristic data generated by applying an external operation and a re-encryption to decrypted preference data from the external apparatus; applying an internal operation to information of the plurality of users and the plurality of pieces of content through the received characteristic data; and predicting preference of the user to second content different from the first content based on the information subjected to the internal operation of the plurality of users and the plurality of pieces of content, and providing predicted preference information of the user to the second content.

The transmitting the encrypted preference data to the external apparatus may include applying preprocessing and masking for an external operation to the input data, and the receiving characteristic data generated by applying an external operation and a re-encryption to the decrypted preference data from the external apparatus may include applying unmasking to the received re-encrypted data.

The storing information about a plurality of users and a plurality of pieces of content may include encrypting and storing the information about the plurality of users and the plurality of pieces of content.

The external operation may include a gradient descent operation.

The internal operation may include matrix factorization applied to the plurality of users and the plurality of pieces of content, and the characteristic data generated by the external operation may include a gradient used in the matrix factorization.

The performing the internal operation may include generating a user profile and a content profile by applying the internal operation to the information about the plurality of users and the plurality of pieces of content; and predicting preference of the user to the second content based on the generated user profile and content profile.

The method of controlling the electronic apparatus may further include determining whether the received re-encrypted data is within a range of a predetermined critical level; and transmitting the received re-encrypted data to the external apparatus for the external operation if it is determined that the received re-encrypted data is out of the range.

The determining whether the received re-encrypted data is within a range of a predetermined critical level may include transmitting information about a predetermined critical level and the received re-encrypted data to the external apparatus in order to determine whether the received re-encrypted data is within a range of a predetermined critical level; and receiving a result of determination from the external apparatus.

Other aspects, advantages, and salient features of the disclosure will become apparent to those skilled in the art from the following detailed description, which, taken in conjunction with the annexed drawings, disclosures various example embodiments of the disclosure.

### BRIEF DESCRIPTION OF THE DRAWINGS

The above and other aspects, features, and advantages of certain example embodiments, will be more apparent from the following detailed description, taken in conjunction with the accompanying drawings, in which like reference numerals refer to like elements, and wherein:

FIG. 1 is a diagram illustrating an example system for providing recommendation information to a user according to an example embodiment;

FIG. 2 is a diagram illustrating an example of using a user terminal according to an example embodiment;

FIG. 3 is a diagram illustrating an example of using a user terminal according to an example embodiment;

FIG. 4 is a diagram illustrating an example of a data structure according to an example embodiment;

FIG. 5 is a diagram illustrating an example of the user profile generated by applying matrix factorization to the data structure of FIG. 4;

FIG. 6 is a diagram illustrating an example of an item profile created by applying matrix factorization to the data structure of FIG. 4;

FIG. 7 is a control flowchart illustrating an example system for generating recommendation information according to an example embodiment; and

FIG. 8 is a diagram illustrating example expressions for explaining the control flowchart of FIG. 7.

Throughout the drawing, like reference numerals will be understood to refer to like parts, components, and structures.

### DETAILED DESCRIPTION

The following description with reference to the accompanying drawings is provided to assist in a comprehensive understanding of various example embodiments of the disclosure. The description includes various details to assist in that understanding but these are to be regarded as merely examples. Accordingly, those of ordinary skill in the art will recognize that various changes and modifications of the various example embodiments described herein may be made without departing from the scope and spirit of the disclosure. In addition, descriptions of well-known functions and constructions may be omitted for clarity and conciseness.

The terms and words used in the following description and claims are not limited to the bibliographical meanings, but, are merely used to enable a clear and consistent understanding of the disclosure. Accordingly, it should be apparent to those skilled in the art that the following description of various example embodiments of the disclosure is provided for illustration purpose only and not for the purpose of limiting the disclosure.

It is to be understood that the singular forms “a,” “an,” and “the” include plural referents unless the context clearly dictates otherwise. Thus, for example, reference to “a component surface” includes reference to one or more of such surfaces.

Some of the elements illustrated in accompanying drawings have been exaggerated, omitted or briefly illustrated, and the size of each element does not wholly reflect the actual size. The disclosure is not limited by the relative size or interval illustrated in accompanying drawings.

If an element is described as “including” another element throughout this description, it means the former may further include the latter rather than excluding other elements unless otherwise specifically provided herein. The term “portion” used in this specification may refer, for example, to software field-programmable gate array (PFGA) or hardware such as application-specific integrated circuit (ASIC), and may be configured to perform certain roles. However, the term “portion” is not limited to the software or hardware, and may be configured to be in an addressable storage medium, or may be configured to reproduce one or more processors. Thus, as an example, the term “portion” may include, for example, elements such as software elements, object-oriented software elements, class elements and task elements, and processes, functions, features, procedures, sub-routines, segments of program codes, drivers, firmware, micro codes, circuits, data, database, data configurations, tables, arrays and variables. The functionality provided in the elements and or portions may be coupled to a smaller number of elements and parts or further divided into additional elements and portions.

With reference to accompanying drawings, example embodiments of the disclosure will be described in greater detail below for those skilled in the art to understand and realize various aspects of the disclosure without difficulty. The disclosure may be achieved in various forms, and is not limited to the example embodiments provided herein. To clearly describe the disclosure, those details unrelated to the description may have been omitted, and like reference numerals denote like elements throughout this description.

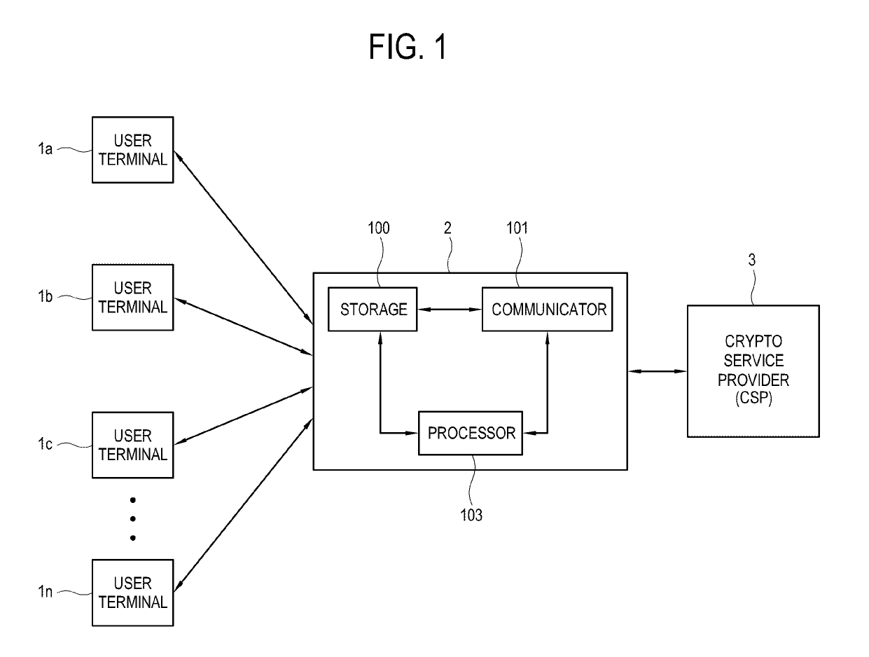

FIG. 1 is a diagram illustrating an example system for providing recommendation information to a user according to an example embodiment. The system according to an example embodiment includes a plurality of user terminals 1a-1n providing a user's preference data, an electronic apparatus 2 for providing recommendation information, and a crypto service provider (CSP) 3 having a public encryption key.

The user terminals 1a-1n receive preference data from a user and transmit preference data encrypted based on the received preference to the electronic apparatus 2, and the electronic apparatus 2 transmits the encrypted preference data to the CSP 3. The CSP 3 decrypts the preference data received from the electronic apparatus 2, applies operation to the decrypted preference data, encrypts the data again, and returns the encrypted data to the electronic apparatus 2.

The electronic apparatus 2 according to an example embodiment receives the preference data about content or an item input by a user, and efficiently applies the matrix factorization to the preference data. The electronic apparatus 2 applies an operation to the received data processed and encrypted by the CSP 3, and thus provides recommendation information in response to a user's request.

The user terminals la-in may refer, for example, to devices capable of receiving a user's input and transmitting data to the electronic apparatus 2 or the like. The user terminals la-in may include various electronic apparatuses such as, for example, and without limitation, a mobile phone, a smart phone, a tablet computer, a personal computer, a laptop computer, etc. A user's input based on his/her control, input to and stored in the terminals la-in, may be encrypted for protection. However, the existing encryption method has a problem that data is easily accessed if an encryption key is published. For security, information that needs to be secured, such as a user's preference data or the like personal information and parameters or the like used for the matrix factorization in the electronic apparatus 2, may be encrypted by a public key cryptosystem. In the public key cryptosystem, an encryption key used for encrypting data is published, but a decryption key used for decrypting the data is given to only the CSP 3.

The electronic apparatus 2 preprocesses the encrypted data received from the user terminals la-in and transmits it to the CSP 3, and the CSP 3 decrypts the data and transmits the decrypted data by, for example, masking to prevent and/or avoid exposure of the personal information.

Below, symbols, signs and expressions used herein will be defined.

n users may input preference to some of m items. For example, a pair of user/item reflecting the preference may be represented by M⊂[n]×[m], where [n]:={1, . . . , n} is a set of users and [m]:={1, . . . , m} is a set of items. Regarding (i,j) ∈M, the preference input by a user i with regard to an item j will be represented by r_{i,j} ∈ R.

Based on r_{i,j}, user information and item information, the electronic apparatus creates a matrix of d columns, e.g. the user profile (Ui∈ R^{d}) and an item profile (Vj∈ R^{d}) having a dimension d smaller than n or m. The matrix of the user profile is represented by U, and the matrix of the item profile is represented by V.

The input preference data (r_{i,j}) of a user undergoes matrix factorization, thereby generating matrixes of U and V. The generated profile is used in predicting a preference to an item j with regard to a user i. The prediction value is determined by the inner product <Ui, Vj> of two matrixes, and this is the same as application of <Ui, Vj> to r_{i,j}. This is to determine profiles U and V for normalized least squares minimization by the following expression.

$${min}_{U , V} \frac{1}{M} {\sum }_{( i , j ) ∈ ℳ} {( {r}_{ij} - 〈 {u}_{i} , {v}_{j} 〉 )}^{2} + λ {\sum }_{i ∈ [ n ]} {‖ {u}_{i} ‖}_{2}^{2} + μ {\sum }_{j ∈ [ m ]} {‖ {v}_{j} ‖}_{2}^{2} \qquad [ Expression 1 ]$$

There are various methods of solving the foregoing expression. In this example embodiment, a gradient descent is used to solve the foregoing expression. In the Expression 1, if the normalized mean square error is represented by F(U, V), the gradient descent performs an operation of repetitively adapting the profiles U and V through adaptation rules, thereby deriving the following expressions.

uᵢ(t)=uᵢ(t−1)−γ∇ᵤᵢF(U(t−1), V(t−1)), vⱼ(t)=vⱼ(t−1)−γ∇ᵥⱼF(U(t−1), V(t−1)), [Expression 2]

where, γ is a gain factor greater than 0. Expression 1 is to add a determined gradient to Ui obtained up to time t-1 in connection with the gain factor. With regard to the input preference data (r_{i,j}), the gradients of U and V are obtained as follows.

$$\begin{matrix}{∇}_{{u}_{i}} F ( U , V ) = {∇}_{{u}_{i}} \\ = {\sum }_{j : ( i , j ) ∈ ℳ} {v}_{j} ( 〈 {u}_{i} , {v}_{j} 〉 - {r}_{ij} ) + λ {u}_{i} ,\end{matrix} \\ \begin{matrix}{∇}_{{v}_{j}} F ( U , V ) = {∇}_{{v}_{j}} \\ = {\sum }_{i : ( i , j ) ∈ ℳ} {u}_{i} ( 〈 {u}_{i} , {v}_{j} 〉 - {r}_{ij} ) + λ {v}_{j} ,\end{matrix} \qquad [ Expression 3 ]$$

Expression 3 illustrates a process of determining the gradients of U and V with ui, vj and r_{i,j}. Initial profiles U(0) and V(0) are first obtained as one row of uniform random norms to determine the gradient ∇, U and V.

Below, a process of predicting preference to an item corresponding to a user's no input through Expression 1, Expression 2 and Expression 3 and providing relevant information will be described.

In this example embodiment, the items may include all kinds of contents such as movies, music, books, cars, electronic apparatuses, regions, nations, etc. to which a user can input his/her preference.

The electronic apparatus 2 may include a communicator (e.g., including communication circuitry) 101, a storage 100 and at least one processor 103.

The communicator 101 includes various communication circuitry that may be configured to communicate with an external apparatus such as the user terminals 1a-1n, the CSP 3, etc. For example, the electronic apparatus 2 may be configured to receive a user's encrypted preference data from the user terminal 1a-1n through the communication circuitry communicator 101, and transmit the received preference data to the CSP 3. The communicator 101 may include various communication circuitry, including, for example, and without limitation, a plurality of connection ports corresponding to various standards such as high definition multimedia interface (HDMI), universal serial bus (USB), etc. so as to connect with an external apparatus, a network or the like. The communicator 101 may include various communication circuitry that performs a plurality of wired communications through a local area network (LAN) by a wire. In addition, the communicator 101 may include various communication circuitry to perform wireless communications. The communicator 101 may include various communication circuitry, including, for example, and without limitation, a radio frequency (RF) circuit for transmitting and receiving an RF signal for wireless communication, and may be configured to perform one or more communications among Wi-Fi, Bluetooth, Zigbee, ultra-wide band (UWB), wireless USB and near field communication (NFC).

The storage 100 may be configured to store various pieces of information such as preference data received from the user terminals 1a-1n, information about users and items, parameters for matrix factorization, initial profiles, etc. The storage 100 may be achieved by various storage types, including, for example, and without limitation, a nonvolatile memory (e.g. a writable read only memory (ROM)) in which data is retained to reflect changes even though power supplied to the electronic apparatus 2 is shut off. For example, the storage 100 may be achieved by one among a flash memory, erasable and programmable read only memory (EPROM) or electrically erasable and programmable read only memory (EEPROM). The storage 100 may store a system software, e.g., an operating system that not only manages system hardware of the electronic apparatus 2 but also provides a system service in common with a hardware abstraction platform for executing a program inside the electronic apparatus 2. Detailed operations of the electronic apparatus 2 may be implemented as a processor 103, including processing circuitry, such as, for example, a central processing unit (CPU), works on the operating system stored in the storage 100. The storage 100 may include a volatile memory in which data may be lost when the electronic apparatus 2 is powered off. For example, the storage 100 may be achieved by either of a dynamic random access memory (DRAM) or a static random access memory (SRAM) which can write and read information and of which reading or writing speed is higher than that of the nonvolatile memory.

At least one processor 103 is configured to control various operations of the electronic apparatus 2 by executing the operating system stored in the storage 100. For example, if a user's encrypted preference data with respect to content among the plurality of pieces of content is received from at least one of the user terminals 1a-1n, the processor 103 of the electronic apparatus 2 may apply preprocessing and masking to the received preference data and provide it to the CSP 3. Further, the processor 103 may be configured to receive data, which is obtained by applying an operation to and encrypting again the decrypted data in the CSP 3, from the CSP 3; remove the masking from the data received from the CSP 3 and internally apply an operation to the unmasked data; and provide recommendation information about different content, to which a user does not input his/her preference, based on the data processed by the internal operation. The recommendation information about different content may be provided in response to a request for recommendation from the user terminals 1a-1n. Further, the processor 103 may provide recommendation information about a result of predicting the preference in response to a request for recommendation about certain content to which preference is not input. According to another example embodiment, the processor 103 may be configured to provide information about a plurality of pieces of content predicted to have preset preference level or higher.

As described above, the electronic apparatus 2 may apply the operations such as the preprocessing, the masking, etc. without decrypting the encrypted data. However, the data may be encrypted by full homomorphic encryption (FHE) so that the electronic apparatus 2 can directly process the encrypted data as desired without decrypting the encrypted data. As an example of FHE, there are various encryption fashions such as Ring LWE, LWE, Hash Elgmal, Paillier, etc. FHE is characterized in that a value obtained by applying an operation to the decrypted original data is equal to a value obtained by decryption after applying the operation the encrypted data. Thus, according to an example embodiment, encrypted data is first subjected to an operation based on the FHE fashion in the electronic apparatus 2 and then transmitted to the CSP 3. The CSP 3 receives and decrypts the encrypted data and then applies the other operations to the decrypted data. By the FHE fashion, it is possible to reduce time taken in performing the operations and completely processing the data.

In addition, the electronic apparatus 2 may apply the masking to data by adding or deleting a randomly formed bitwise pattern to or from the data. Thus, the CSP 3 cannot know data actually input by a user even though the making data is decrypted, and thus security for data is improved.

The electronic apparatus 2 is an apparatus for processing input data and providing information based on the processed data, and may include various electronic apparatuses such as a computer, a server or the like as long as it can process data and exchange the processed data with an external apparatus.

The CSP 3 is an apparatus for storing a decryption key in the public key cryptosystem. Like the electronic apparatus 2, the CSP 3 may include a communicator including communication circuitry for communicating with an external apparatus, a storage for storing the encryption key or the like information, and a processor for controlling general operations of the CSP 3.

The CSP 3 receives the encrypted, preprocessed and masking data from the electronic apparatus 2. The CSP 3 first decrypts the received data and then applies an operation to the decrypted data. Since the electronic apparatus 2 preprocesses the data before transmitting the data to the CSP 3, the operations in the CSP 3 are reduced. The preprocesses to be performed in the electronic apparatus 2 may include inner product between vectors, and the operations to be performed in the CSP 3 may include the other operations except the inner product between vectors. Although the CSP 3 decrypts the data, preference data or the like actually input by a user is not exposed due to the masking inserted by the electronic apparatus 2.

The CSP 3 may be achieved by a separate electronic apparatus or server as described above. However, this is merely an example embodiment. Alternatively, the CSP 3 may be achieved by a separate chip having a public encryption key and placed inside the electronic apparatus 2. Even if the CSP 3 is achieved by a separate chip, the CSP 3 may include a separate memory to store a public encryption key.

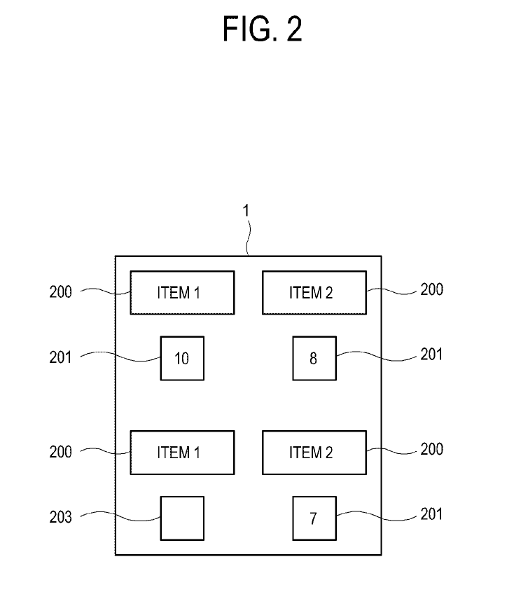

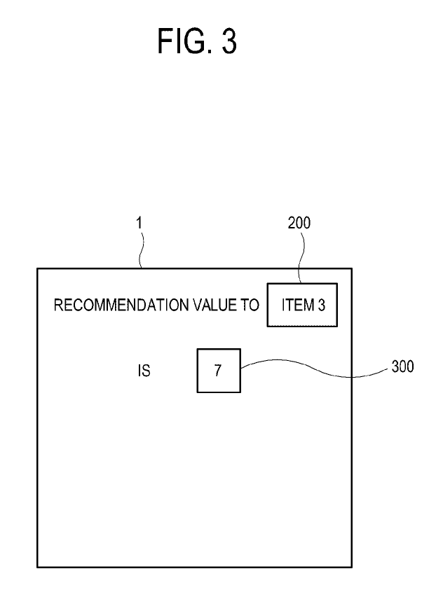

FIGS. 2 and 3 are diagrams illustrating examples of using a user terminal according to an example embodiment;

FIG. 2 illustrates a user terminal 1 that provides a user interface (UI), allowing a user to input his/her preference about a certain item or content, through a display.

The UI provided by the user terminal 1 may include, for example, a component 200 corresponding to each item, and components 201 and 203 for inputting preference to the item. A user inputs the preference to at least one item 200 among the plurality of items, and inputs no preference to the other item 200. The component corresponding to no input is left as a blank 203. The user terminal 1 encrypts the preference input by a user, and transmits the encrypted data to the electronic apparatus 2.

FIG. 3 illustrates an example of providing preference 300 predicted with respect to the item 200 to which a user inputs no preference through the UI of FIG. 2. As described above, the electronic apparatus 2 predicts a user's preference with respect to the item 200 to which the user inputs no preference, based on the user profile and an item profile generated by applying the matrix factorization to the data in the CSP 3. Further, the electronic apparatus 2 generates relevant information based on a user's predicted preference, and provides the generated relevant information to the user terminal 1 receiving the preference data. The electronic apparatus 2 is configured to provide a user with a UI that shows the item 200 corresponding to a user's no input and the predicted preference 300.

FIGS. 2 and 3 are provided merely for illustrative purpose, and the disclosure is not limited to the foregoing description and accompanying drawings. There may be various and different UI's for receiving a user's preference about a certain item or his/her desired content and a UI for providing the recommendation information to a user.

According to another example embodiment, the electronic apparatus 2 may make a list of items, which has a preset preference level or higher, among a plurality of items having the predicted preference, and provide the list to a user. Further, the electronic apparatus 2 may provide not only the titles of the items but also various pieces of information related to the item selected based on the predicted preference.

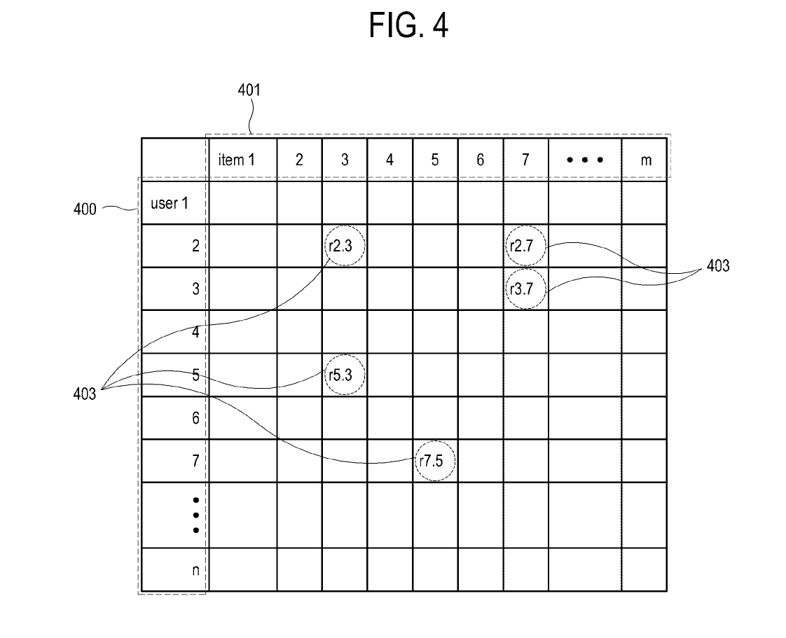

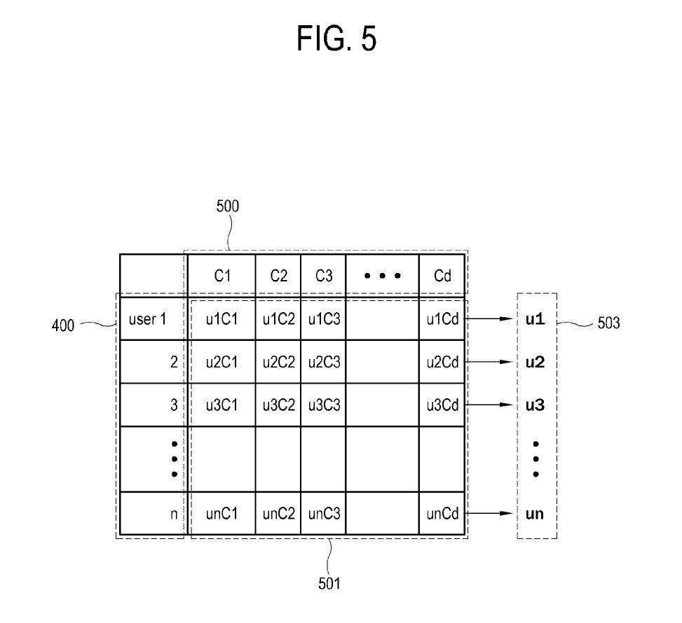

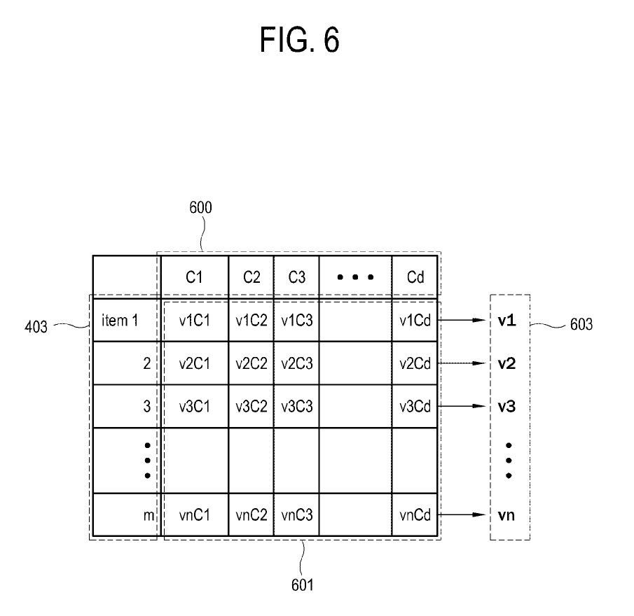

FIG. 4 is a diagram illustrating an example of a data structure according to an example embodiment, and FIGS. 5 and 6 respectively are diagrams illustrating an example of the user profile and an item profile generated by applying matrix factorization to the data structure of FIG. 4.

The user profile is a matrix defining a user, and reflects a yardstick or measure of a user's likes and dislikes, e.g., a user's personality. For example, if a selected item is a movie, the user profile shows information about whether genres of the movie users like are comedy, action, horror, or the like in response to the preference data input by a user 1, e.g., shows information about what item a certain user likes.

Likewise, the item profile is a matrix defining the items, and reflects the characteristics or properties of the items. For example, the item profile shows information about a user's preference divided according to ages, religions, sex, etc. with respect to the item 1, e.g., shows information about the characteristics of the items.

The user profile shows users' propensities based on the items, and the item profile is related to the preference based on users' propensities with respect to each item. For example, both the user profile and the item profile involve users' and items' own characteristics related to the preference.

The electronic apparatus 2 may be configured to generate the data structure of FIG. 4 based on the preference data input by a user, and to generate the user profile and the item profile by applying the matrix factorization to the data structure. The electronic apparatus 2 may be configured to generate a prediction value by predicting the preference with respect to the item, to which a user does not input the preference, based on the user profile and the item profile. The electronic apparatus 2 may provide the prediction value to at least one user terminal 1, which makes a request for the recommendation value, from among the plurality of user terminals 1a-1n.

The data structure, generated by the electronic apparatus 2 based on the information about users and items, is illustrated in FIG. 4. The data structure may be a matrix of [n]×[m], and contains input data 403 obtained by tabulating preference input of n users 400 with respect to m items 401.

The electronic apparatus 2 and the CSP 3 perform linked operations based on user's input data 403. For example, the electronic apparatus 2 and the CSP 3 generate the user profile and the item profile by applying the matrix factorization to the data structure. As a result of the matrix factorization, an example of the generated user profile is illustrated in FIG. 5, and an example of the generated item profile is illustrated in FIG. 6.

The user profile has n row vectors 503 corresponding to a plurality of users 400 and d column vectors 500 in, for example, a matrix form 501. The number of column vectors 500, e.g., ‘d’ is set to be smaller than the number of items, e.g., ‘m’. Each column vector 500 is related to each user's preference to the items or content.

Like the user profile, the item profile has m row vectors 603 corresponding to the plurality of pieces of content, e.g., items 403, and d column vectors 600 in for example, a matrix form 601. In the item profile, ‘d’ is set to be smaller than the number of users, e.g., ‘n’. In the item profile, each column vector 600 is related to each user's preference to the items.

The electronic apparatus 2 may perform an operation of predicting preference to an item corresponding to no input of the preference with respect to a user who inputs the preference, through the user profile and the item profile.

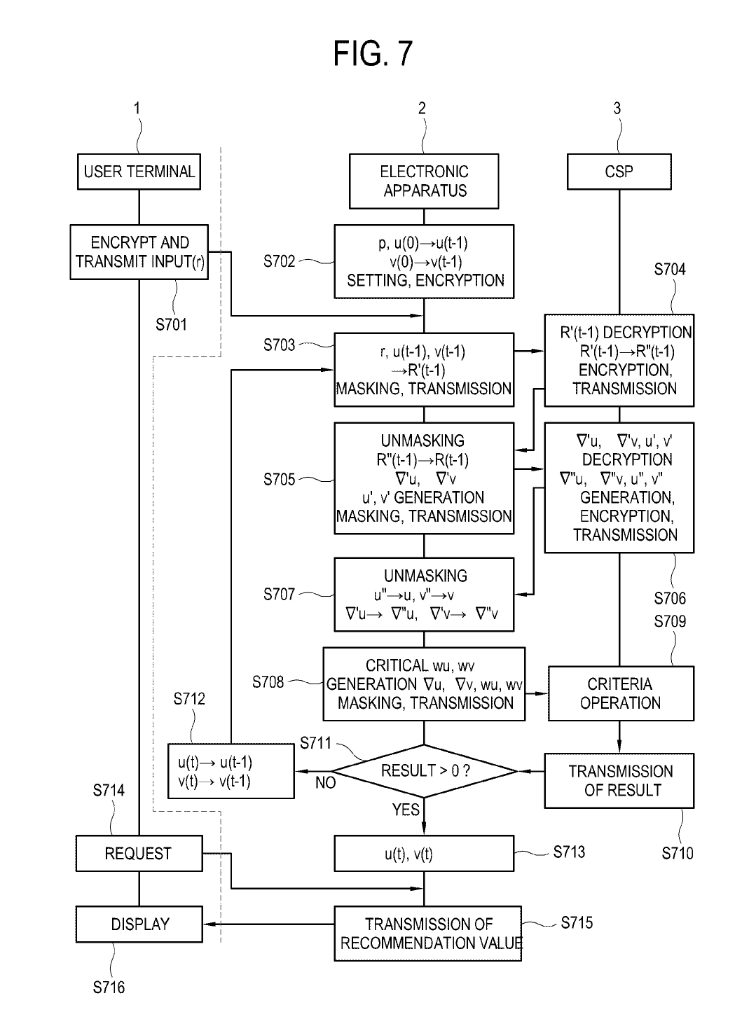

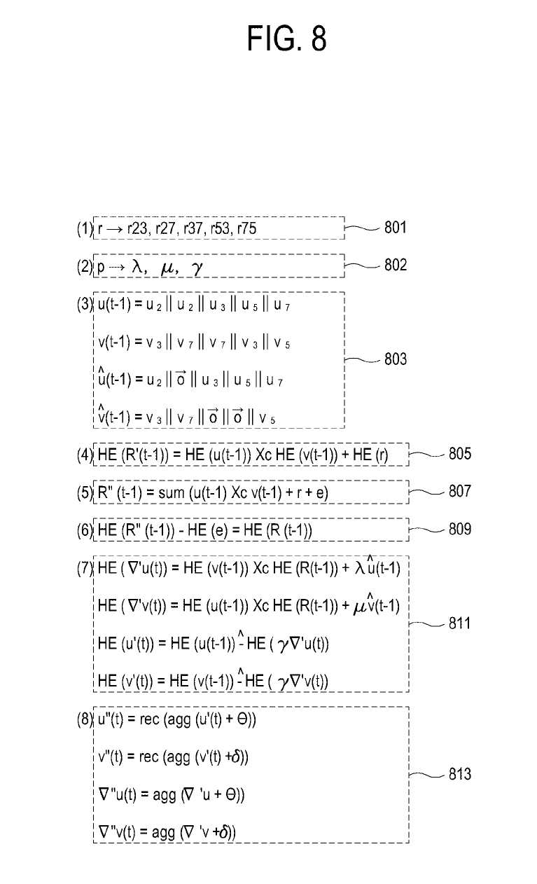

FIG. 7 is a control flowchart illustrating an example system for generating recommendation information according to an example embodiment, and FIG. 8 is a diagram illustrating example expressions for explaining the control flowchart of FIG. 7.

At operation S701, a user inputs his/her preference to a certain item to the user terminal 1. The user terminal 1 encrypts the input preference data r by a public encryption key and transmits the encrypted data to the electronic apparatus 2. Referring to the components 403 illustrated in FIG. 4, the preference data input by a user is as follows: a user 2 inputs his/her preference to the items 3 and 7, a user 3 inputs his/her preference to the item 7, a user 5 inputs his/her preference to the item 3, and a user 7 inputs his/her preference to the item 5. In FIG. 8, Expression (1) 801 represents the preference data input by users.

At operation S702, the electronic apparatus 2 sets a parameter p, and respectively sets initial profile matrixes U(t-1) and V(t-1) as U(0) and V(0) so as to perform the recommendation. The electronic apparatus 2 sets U(0) and V(0) through a random norm at an initial operation, and uses results of previous determination as an initial profile matrix since then.

In FIG. 8, Expression (2) 802 illustrates examples of parameters. μ and [symbol] are respectively set to calculate the gradients of the user profile (u) and the item profile (v) and γ is set to serve as a gain factor applied to the obtained gradient.

The initial profiles, U(t-1) and V(t-1) are represented by the two above equations in Expression (3) 803. Here, u₂, u₃, u₅ and u₇ refer to row vectors of the user profile U(t-1). Symbols ‘∥’ used between the vectors mean that components of the vector are arranged. For example, the components of the equation U(t-1) in the Expression (3) are arranged as follows: U(t-1)={u_{2,1}, . . . , u_{2,d}, u_{2,1}, . . . , u_{2,d}, u_{3,1}, . . . , u_{3,d}, u_{5,1}, . . . , u_{5,d}, u_{7,1}, . . . , u_{7,d}}. Referring to u₂ of U(t-1), it will be appreciated that a user 2 inputs the preference data with respect to two items. Referring to v₇ of V(t-1), it will be appreciated that two users inputs the preference data to one item and thus this item is duplicately used. The two below equations in Expression (3) 803 refers to the vectors U and V from which the duplicated vectors are removed. The electronic apparatus 2 encrypts U(t-1) and V(t-1) with the public encryption key.

At operation S703, the electronic apparatus 2 generates R′ (t-1) vector, applies the masking to the generated vector, and transmits it to the CSP 3.

First, the electronic apparatus 2 generates R′ (t-1) vector based on the encrypted preference data, U(t-1) and V(t-1). The Expression (4) 805 represents an equation of generating R′ (t-1) vector. The symbol ‘HE’ in the Expression (4) 805 refers to the encryption. The Symbol ‘xc’ refers to component-wise multiplication, and means that that the encrypted components of U(t-1) {u_{2,1}, . . . , u_{2,d}, u_{2,1}, . . . , u_{2,d}, u_{3,1}, . . . , u_{3,d}, u_{3,d}, u_{5,1}, . . . , u_{5,d}, u_{7,1}, . . . , u_{7,d}} and the encrypted components of V(t -1) {v_{3,1}, . . . , v_{3,d}, v_{7,1}, . . . , v_{7,d}, v_{7,1}, . . . , v_{7,d}, v_{3,1}, . . . , v_{3,d}, v_{5,1}, . . . , v_{5,d}} are all multiplied and then arranged. That is, an operation result of U(t-1)×c V(t-1) performed with respect to the example illustrated in FIG. 4 is as follows: {u_{2,1}×v_{3,1}, . . . , u_{2,d}×v_{3,d}, u_{2,1}×v_{7,1}, . . . , u_{2,d}×v_{7,d}, u_{3,1}×v_{7,1}, . . . , u_{3,d}×v_{7,d}, u_{5,1}×v_{3,1}, . . . , u_{5,d}×v_{3,d}, u_{7,1}×v_{5,1}, . . . , u_{7,d}×v_{5,1}, . . . u_{7,d}×v_{5,d}}. The component multiplication is a partial operation of the inner product between the vectors, and is performed in the encryption state of the electronic apparatus 2. The electronic apparatus 2 adds the preference data to each component of U(t-1) and V(t-1) to which the component multiplication is applied. Then, the electronic apparatus 2 applies the masking to R′ (t-1) and transmits it to the CSP 3.

At operation S704, the CSP 3 decrypts R′ (t-1) with the decryption key. Then, the other operations of the inner product is applied to the decrypted R′ (t-1), and thus R″ (t-1) is generated. Then, R″(t-1) is encrypted again and transmitted to the electronic apparatus 2.

In FIG. 8, the Expression (5) 807 shows an equation for generating R″(t-1). In the Expression (5) 807, e is an error function for making the electronic apparatus 2 do the masking in the previous operation S703. Further, sum used in the Expression (5) 807 refers to sum of arranged components. Regarding the example illustrated in FIG. 4, an operation result of sum(U(t-1)×c V(t-1)) is equal to {u_{2,1}×v_{3,1}+ . . . +u_{2,d}×v_{3,d}, u_{2,1}×v_{7,1}+ . . . +u_{2,d}×v_{7,d}, v_{3,1}×v_{7,1}+. . . +u_{3,d}×v_{7,d}, u_{5,1}×b_{3,1}+. . . +u_{5,d}×v_{3,d}, u_{7,1}×v_{5,1}+. . . +u_{7,d}×v_{5,d}}.

At operation S705, the electronic apparatus 2 applies unmasking to R″(t-1) as shown in the Expression (6) 809 FIG. 8, and thus generates R(t-1). Here, ‘e’ is a random function. To accurately remove the random function in the operation S705, the electronic apparatus 2 may store information about ‘e’ in the storage 100 before transmission to the CSP3 with the error function ‘e’ for the masking. Then, the encrypted R(t-1) is used to generate the encrypted ∇′u, ∇′v, u′ and v′. The generated ∇′u, ∇′v, u′ and v′ are subjected to the masking, and then transmitted to the CSP 3. In FIG. 8, the Expression (7) 811 shows a process of generating the encrypted ∇′u, ∇′v, u′ and v.

At operation S706, the CSP 3 generates ∇″u, ∇″v, u″ and v″ based on the received ∇′u, ∇′v, u′ and v′ and transmits them to the electronic apparatus 2. First, the CSP 3 decrypts the received ∇′u, ∇′v, u′ and v′ and performs the operations of the Expression (8) 813 shown in FIG. 8. Prior to the operations in the Expression (8) 813, the definition of operations agg(aggregation) and rec (reconstitution) is as follows.

First, at M_{I}={i₁, . . . , i₁ᵤ}, M_{J}={J₁, . . . J₁ᵥ}, A=a₁∥. . . ∥a_{M}, the operation agg is performed as follows.

$${agg}_{u} ( A , ℳ ) {\sum }_{j : ( {i}_{1} , j ) ∈ ℳ} {a}_{j} ‖ … ‖ {\sum }_{j : ( {i}_{{l}_{u}} , j ) ∈ ℳ} {a}_{j} , \\ {agg}_{v} ( A , ℳ ) {\sum }_{i : ( i , {j}_{1} ) ∈ ℳ} {a}_{i} ‖ … ‖ {\sum }_{i : ( i , {j}_{{l}_{v}} ) ∈ ℳ} {a}_{i} . \qquad [ Expression 4 ]$$

Further, the operation rec is performed as follows.

recᵤ(aggᵤ, M)=∥_{(i,j)∈M}Aᵢ′, recᵥ(aggᵥ, M)=∥_{(i,j)∈M}Aⱼ″ [Expression 5]

Then, the CSP 3 encrypts the generated ∇″u, ∇″v, u″ and v″ again, and then transmits them to the electronic apparatus 2.

At operation S707, the electronic apparatus 2 applies unmasking to the received ∇″u, ∇″v, u″ and v″ to thereby generate ∇u, ∇v, u and v.

At operation S708, the electronic apparatus 2 sets parameters wu and wv for determining whether the above operation results are correct without deviating from a critical range. The electronic apparatus 2 masks ∇u, ∇v, and set parameters and transmits masked ∇u, ∇v, and set parameters to the CSP 3.

At operation S709, the CSP 3 performs a criteria operation with the received data. The criteria operation is to determine whether the gradients of ∇u and ∇v deviate from the critical range. As a result of the critria operation, a positive value is output if ∇u and ∇v are within the critical range, and a negative value is output if ∇u and ∇v are output of the critical range. Then, at operation S710, the CSP 3 transmits the result of the criteria operation to the electronic apparatus 2.

At operation S711 the electronic apparatus 2 determines whether the result of the criteria operation is greater than 0, e.g., whether the gradients of ∇u and ∇v are within predetermined critical ranges wu and wv, respectively.

If it is determined that the result of the criteria operation is smaller than 0, e.g., if it is determined that the gradients of ∇u and ∇v are out of the predetermined critical ranges wu and wv, respectively, at operation S712 the electronic apparatus 2 sets u(t) and v(t) as the initial profiles u(t-1) and v(t-1) for re-operation and repeats the foregoing operations together with the CSP 3.

If it is determined that the result of the criteria operation is greater than 0, at operation S713 the electronic apparatus 2 outputs u(t) and v(t) as the result values.

When a user issues a command for requesting content recommendation to the user terminal 1, at operation S714 the user terminal 1 makes a request for the recommendation value to the electronic apparatus 2 in response to his/her input. In response to the request for the recommendation value, at operation S715 the electronic apparatus 2 generates the recommendation value based on the user profile of u(t) and the item profile of v(t), and outputs the generated recommendation value to the user terminal 1 which requested for the recommendation value. The operation of generating the recommendation value is achieved by the existing technique of providing the recommendation value using the matrix factorization, and thus detailed descriptions thereof will be omitted. The recommendation value may be a value obtained by predicting preference to an item corresponding to a user's no input, or information provided to a user based on the predicted value. For example, the electronic apparatus 2 predicts the preference to all the other items corresponding to a user's no inputs, and then provides a user with information about the item having preference higher than a certain level as recommended items.

Lastly, at operation S716 the user terminal 1 provides information based on the received recommendation value to a user.

As described above, the electronic apparatus 2 and the CSP 3 according to an example embodiment applies the matrix factorization to the preference data input by a user through the repetitive operations, and thus predicts the preference to the item to which s/he does not input the preference data, thereby providing the recommendation value. The electronic apparatus 2 in this example embodiment may perform multiple operations for a period of time shorter than that taken in performing the matrix factorization using the conventional garbled circuit. Therefore, it is possible to provide more accurate recommendation values to a user within a shorter time.

According to an example embodiment, the matrix factorization is rapidly and repetitively performed, thereby providing more accurate recommendation values to a user.

Although a few example embodiments have been illustrated and described, it will be appreciated by those skilled in the art that changes may be made in these example embodiments without departing from the principles and spirit of the disclosure, the scope of which is defined in the appended claims and their equivalents.

What is claimed is:

1. An electronic apparatus comprising:
communication circuitry configured to communicate with a plurality of user terminals and an external apparatus;
a storage configured to store information of a plurality of users and a plurality of pieces of content; and
at least one processor configured to receive encrypted preference data of a user to first content from among the plurality of pieces of content from at least one among the plurality of user terminals through the communication circuitry, to transmit the encrypted preference data to the external apparatus, to receive characteristic data generated by applying an external operation and a re-encryption to decrypted preference data from the external apparatus, to apply an internal operation to information of the plurality of users and the plurality of pieces of content through the received characteristic data, to predict a preference of the user to second content different from the first content based on the information subjected to the internal operation of the plurality of users and the plurality of pieces of content, and to provide the predicted preference information of the user to the second content.

2. The electronic apparatus according to claim 1, wherein the encryption and re-encryption comprise full homomorphic encryption (FHE).

3. The electronic apparatus according to claim 1, wherein the at least one processor is configured to apply preprocessing and masking for an external operation to the input data, to transmit the data subjected to the preprocessing and the masking to the external apparatus, to apply unmasking to the received re-encrypted data and to apply the internal operation to the data subjected to the unmasking.

4. The electronic apparatus according to claim 1, wherein the at least one processor is configured to encrypt the information of the plurality of users and the plurality of pieces of content and to store the encrypted information in the storage.

5. The electronic apparatus according to claim 1, wherein the external operation comprises a gradient descent operation.

6. The electronic apparatus according to claim 1, wherein the internal operation comprises matrix factorization applied to the plurality of users and the plurality of pieces of content, and
the characteristic data generated by the external operation comprises a gradient used in the matrix factorization.

7. The electronic apparatus according to claim 6, wherein the at least one processor is configured to generate a user profile and a content profile by applying the internal operation to the information of the plurality of users and the plurality of pieces of content, and to predict the preference of the user to the second content based on the generated user profile and content profile.

8. The electronic apparatus according to claim 1, wherein the at least one processor is configured to determine whether the received re-encrypted data is within a range of a predetermined critical level, and to transmit the received re-encrypted data to the external apparatus for the external operation if it is determined that the received re-encrypted data is out of the range.

9. The electronic apparatus according to claim 8, wherein the at least one processor is configured to transmit information of the predetermined critical level and the received re-encrypted data to the external apparatus to determine whether the received re-encrypted data is within the range of the predetermined critical level, and to receive a result of determination from the external apparatus.

10. The electronic apparatus according to claim 1, wherein the at least one processor is configured to provide information of a user and content, which has been subjected to the internal operation, to a user terminal that makes a request for information from among the plurality of user terminals.

11. The electronic apparatus according to claim 1, wherein the at least one processor is configured to predict a preference to content other than the first content from among the plurality of pieces of content, and to provide recommendation content based on the predicted preference to the other content.

12. The electronic apparatus according to claim 10, wherein the recommendation content has a preference equal to or greater than a critical level from among the plurality of pieces of content.

13. A method of controlling an electronic apparatus, the method comprising:
communicating with a plurality of user terminals and an external apparatus;
storing information of a plurality of users and a plurality of pieces of content;
receiving encrypted preference data of the user to first content from among the plurality of pieces of content from at least one among the plurality of user terminals;
transmitting the encrypted preference data to the external apparatus;
receiving characteristic data generated by applying an external operation and a re-encryption to decrypted preference data from the external apparatus;
applying an internal operation to information of the plurality of users and the plurality of pieces of content through the received characteristic data; and
predicting a preference of the user to second content different from the first content based on the information subjected to the internal operation of the plurality of users and the plurality of pieces of content, and providing the predicted preference information of the user to the second content.

14. The method according to claim 13, wherein
the transmitting the encrypted preference data to the external apparatus comprises applying preprocessing and masking for an external operation to the input data, and
the receiving characteristic data generated by applying an external operation and a re-encryption to the decrypted preference data from the external apparatus comprises applying unmasking to the received re-encrypted data.

15. The method according to claim 13, wherein the storing information of a plurality of users and a plurality of pieces of content comprises encrypting and storing the information of the plurality of users and the plurality of pieces of content.

16. The method according to claim 13, wherein the external operation comprises a gradient descent operation.

17. The method according to claim 16, wherein
the internal operation comprises matrix factorization applied to the plurality of users and the plurality of pieces of content, and
the characteristic data generated by the external operation comprises a gradient used in the matrix factorization.

18. The method according to claim 17, wherein
the performing the internal operation comprises:
generating a user profile and a content profile by applying the internal operation to the information of the plurality of users and the plurality of pieces of content; and
predicting preference of the user to the second content based on the generated user profile and the generated content profile.

19. The method according to claim 13, further comprising:
determining whether the received re-encrypted data is within a range of a predetermined critical level; and
transmitting the received re-encrypted data to the external apparatus for the external operation if it is determined that the received re-encrypted data is out of the range.

20. The method according to claim 19, wherein the determining whether the received re-encrypted data is within a range of a predetermined critical level comprises:
transmitting information about a predetermined critical level and the received re-encrypted data to the external apparatus in order to determine whether the received re-encrypted data is within a range of a predetermined critical level; and
receiving a result of determination from the external apparatus.
